(19) United States
(12) Patent Application Publication
(10) Pub. No.: US 2026/0126986 A1
(43) Pub. Date: May 7, 2026

(54) USING SERVER GENERATIONS TO ENABLE BLUE-GREEN UPGRADES IN CONTAINERIZED ENVIRONMENTS

(71) Applicant: SAP SE, Walldorf (DE)

(72) Inventors: Welf Walter, Waghäusel (DE); Steffen Meissner, Heidelberg (DE); Kerstin Hoeft, Wiesloch (DE); Heiko Konrad, Hockenheim (DE); Alexander Koch, St. Leon-Rot (DE); Thomas Ullrich, Stutensee (DE); Volker Driesen, Heidelberg (DE)

(21) Appl. No.: 18/937,668

(22) Filed: Nov. 5, 2024

(51) Int. Cl. G06F 8/656; G06F 16/21

(52) U.S. Cl. CPC G06F 8/656; G06F 16/213

(57) ABSTRACT

A computer-implemented method includes determining, using an upgrade tool, a current server generation value and which database schema is in use. A configuration is written to a system database that, for a computer system generation <x+1>, which is higher than a current computer system generation <x>, a schema associated with the computer system generation <x+1> is a different schema than the schema associated with the current computer system generation <x>, and that, for tools during an upgrade, the schema is the different schema. A database schema for the different schema is prepared. An application server instance is created in an upgrade container. A configuration is written to the system database that application server instances using a server generation value of x+1 use the database schema for a different schema. A custom resource repository is configured to create an entry for the server generation value of <x+1>.

### BACKGROUND

SAP SE's blue-green zero downtime upgrade of systems composed of an application server and database (DB) running in a containerized environment (including smaller changes being deployed—such as, hot fix collections, support packages, and “updates”) works with two DB-schemas—i.e., a blue and a green schema. During an upgrade, usage switches to a respective other schema. Depending on upgrade history, a production system can use blue or green schema and the upgrade tools and switch during the upgrade then uses the respective other schema, this can be individual for different systems in a landscape depending on their individual provisioning time and upgrade history. While a production application server uses one schema, the upgrade uses the respective other schema to prepare a target software version, including connecting application servers to execute application specific tasks for the upgrade, before the users are switched to the new version. Issues with the current procedure include scale-out, scale-in, and server restart/reprovisioning during a deployment procedure that is unaware of the upgrade procedure progress, application servers being provisioned for a system require system-individual configurations and depend on the progress of the upgrade procedure, connection to a DB depends on DB history, and containers cannot be configured statically for all systems in a landscape.

### SUMMARY

The present disclosure describes using server generations to enable blue-green upgrades in containerized environments.

In an implementation, a computer-implemented method, comprises: determining, using an upgrade tool, a current server generation value and which database schema is in use; writing, using the upgrade tool, a configuration to a system database that, for a computer system generation <x+1>, which is higher than a current computer system generation <x>, a schema associated with the computer system generation <x+1> is a different schema than the schema associated with the current computer system generation <x>, and that, for tools during an upgrade, the schema is the different schema; preparing, using the upgrade tool and in the system database, a database schema for the different schema; creating, using the upgrade tool, an application server instance in an upgrade container; writing, using the upgrade tool, a configuration to the system database that application server instances using a server generation value of x+1 use the database schema for a different schema; and configuring, using the upgrade tool, a custom resource repository to create an entry for the server generation value of <x+1>.

The described subject matter can be implemented using a computer-implemented method; a non-transitory, computer-readable medium storing computer-readable instructions to perform the computer-implemented method; and a computer-implemented system comprising one or more computer memory devices interoperably coupled with one or more computers and having tangible, non-transitory, machine-readable media storing instructions that, when executed by the one or more computers, perform the computer-implemented method/the computer-readable instructions stored on the non-transitory, computer-readable medium.

The subject matter described in this specification can be implemented to realize one or more of the following advantages. The described approach decouples different operation processes, such as scale-out and upgrade, and still allows configuring the de-coupled processes and the respective other process to act as configured (e.g., to scale out the old, the new or the old and new application servers, or to create scale-out instances with the configuration settings currently required by the upgrade).

The details of one or more implementations of the subject matter of this specification are set forth in the Detailed Description, the Claims, and the accompanying drawings. Other features, aspects, and advantages of the subject matter will become apparent to those of ordinary skill in the art from the Detailed Description, the Claims, and the accompanying drawings.

### DESCRIPTION OF DRAWINGS

FIG. 1 is an illustration of example parameters involved in the described approach, according to an implementation of the present disclosure.

FIG. 2 is a box diagram illustrating server generations before switch, according to an implementation of the present disclosure.

FIG. 3 is a box diagram illustrating server generations during switch, according to an implementation of the present disclosure.

FIG. 4 is a flowchart illustrating an example of a computer-implemented method for using server generations to enable blue-green upgrades in containerized environments, according to an implementation of the present disclosure.

FIG. 5 is a block diagram illustrating an example of a computer-implemented system used to provide computational functionalities associated with described algorithms, methods, functions, processes, flows, and procedures, according to an implementation of the present disclosure.

Like reference numbers and designations in the various drawings indicate like elements.

### DETAILED DESCRIPTION

The following detailed description describes using server generations to enable blue-green upgrades in containerized environments and is presented to enable any person skilled in the art to make and use the disclosed subject matter in the context of one or more particular implementations. Various modifications, alterations, and permutations of the disclosed implementations can be made and will be readily apparent to those of ordinary skill in the art, and the general principles defined can be applied to other implementations and applications, without departing from the scope of the present disclosure. In some instances, one or more technical details that are unnecessary to obtain an understanding of the described subject matter and that are within the skill of one of ordinary skill in the art may be omitted so as to not obscure one or more described implementations. The present disclosure is not intended to be limited to the described or illustrated implementations, but to be accorded the widest scope consistent with the described principles and features.

The described approach is related to SAP SE's blue-green zero downtime upgrade of systems composed of an application server and database (DB) running in a containerized environment. Smaller changes being deployed (e.g., hot fix collections, support packages, and “updates”) are considered application to the term “upgrade.”

The blue-green upgrade procedure works with two DB-schemas—i.e., a blue and a green schema—and during the upgrade procedure, usage switches to a respective other schema. If a production system is connected/switched to the blue or green schema, the switch depends on system history, especially how many upgrades have been run. While the production application server uses one schema, an upgrade uses the respective other schema to prepare a target software version, including connecting application servers to execute application-specific tasks for the upgrade before users are switched to the new target software version.

During the upgrade procedure, application servers are used both for production use and upgrade preparation. These two groups of application servers are partially acting on the same DB tables—i.e., partially the DB tables had been cloned (providing a blue and a green version of the table, with change replication from the production table to the table being prepared). Since both groups of application servers use partially the same DB tables, an internal isolation mechanism is provided (e.g., “subsystem-isolation”), which, for example, ensures, a production batch job is executed on a production application server and an upgrade batch job is executed on an upgrade server.

For running in a containerized environment, former file system-based profile parameter settings are no longer an entity which can be changed by an upgrade tool. These parameters are only changed by replacing the container by a new version of the container and requiring a “rolling switch” of user load from the application server in the old container to the application server in the new container. Profile parameters are set by the infrastructure when providing a new instance of an image to start in a container. During a run of the upgrade procedure, certain profile parameter settings are adjusted for a production application server and upgrade-specific application servers receive an individual configuration, partially depending on progress of the upgrade procedure (e.g., more dialog work processes or more batch work processes, depending on needs).

During a switch of users from an old version of the application to a new version of the application prepared by the upgrade procedure, application server instances are started for production use for both blue and green schema, and users are at some point switched from application servers connected to blue to application servers connected to green DB schema (or vice-versa). Depending on the compatibility of the deployed change, user requests can be processed in parallel on blue and green (thus using two versions in parallel) or users are switched synchronously, and all incoming requests are either routed to blue or to green. Afterwards the unused application server instances are stopped and, respectively, containers hosting unused application servers are de-commissioned.

In a containerized environment, the system will provide autoscaling capabilities. That is, in case of high load, additional application servers are started (scale-out) and, in case of low load, application servers can be stopped to reduce hardware/resource needs.

### Problem Description

Scale-out, scale-in and server restart/reprovisioning during a deployment procedure needs to be aware of the upgrade procedure progress.

During progress of the deployment procedure, application server configuration is modified. Newly provisioned containers with application servers need to match a configuration specific for a period of the upgrade, otherwise servers might be configured incorrectly, grant access to an incorrect software version, or not be aware of subsystem handling, etc. In detail: 1) subsystem isolation; 2) connect to blue or green; 3) open for users or not; 4) being closed for shut down of the old version; and 5) application servers open for users or used for upgrade steps only.

Application servers being provisioned for a system require system-individual configuration, depending on the progress of the upgrade procedure.

During progress of the procedure, application server configurations are changed. This cannot be done by exchanging application servers by re-deploying containers each time—this would take quite long, especially since there is some workload with long running processes (e.g. batch) or stateful applications. But with a blue-green switch, additional application servers are needed. Therefore, containers are deployed in addition to the running (a server cannot be re-connected from blue to green with zero switch time, since buffers have to be refreshed with software and content of the new version. With the switch to the new version, a new application server container image might be used, and might require a new server version.

Connect to the DB depends on the DB history, containers cannot be configured statically for all systems in a landscape.

Blue or green view layer usage is switched with each maintenance event (potentially in the future also with customer change deployments). Therefore, there may be systems in the landscape which currently require connection to blue while others require connection to green.

Described is an approach to orchestrate different components involved in an upgrade procedure using a configuration parameter (e.g., “server_generation”). Additionally, enabling application server configuration parameters, which are server_generation specific, including database-connect and to set configuration parameters as required at individual steps of the upgrade procedure for the old and new values of the server_generation.

An upgrade tool can create a set of configuration parameters for a new value of a “server_generation,” which can be used in parallel to the previous a set of configuration parameters for the old value of the “server_generation.” With this approach, a “blue” and a “green” DB schema can be created, and application servers can be configured individually to connect either to “blue” or “green” DB schemas.

The application server can be configured using a profile parameter in the file system of the application server container, which server_generation to use. It can read respective configuration parameters from the database, including the DB connect and can connect to the specified DB schema.

An orchestration infrastructure (e.g., an application server instance operator) can read configuration values for server_generations and create/de-commission containers with application servers. The orchestration infrastructure can also inject a server_generation value into the container for the application server being started in the container to read the server_generation value to use.

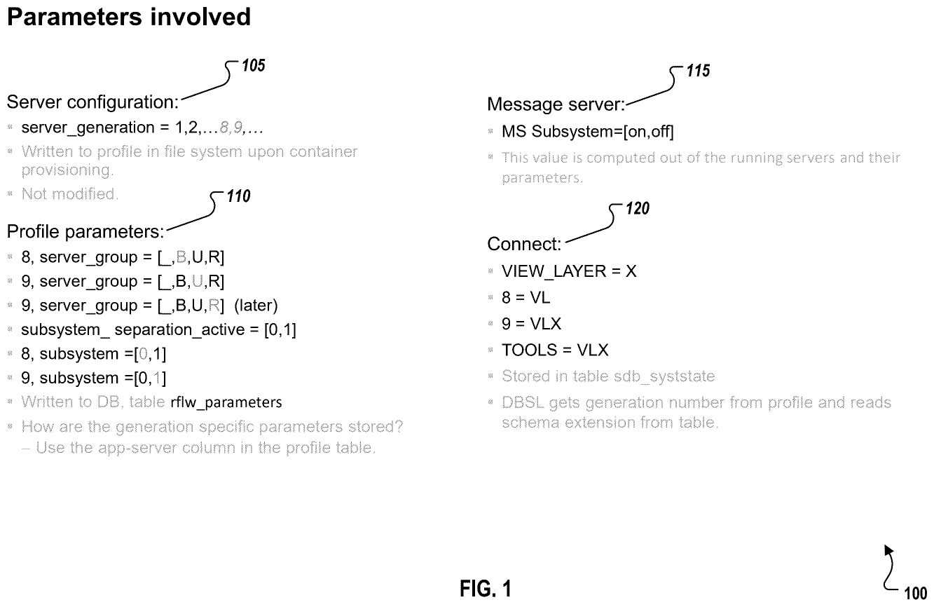

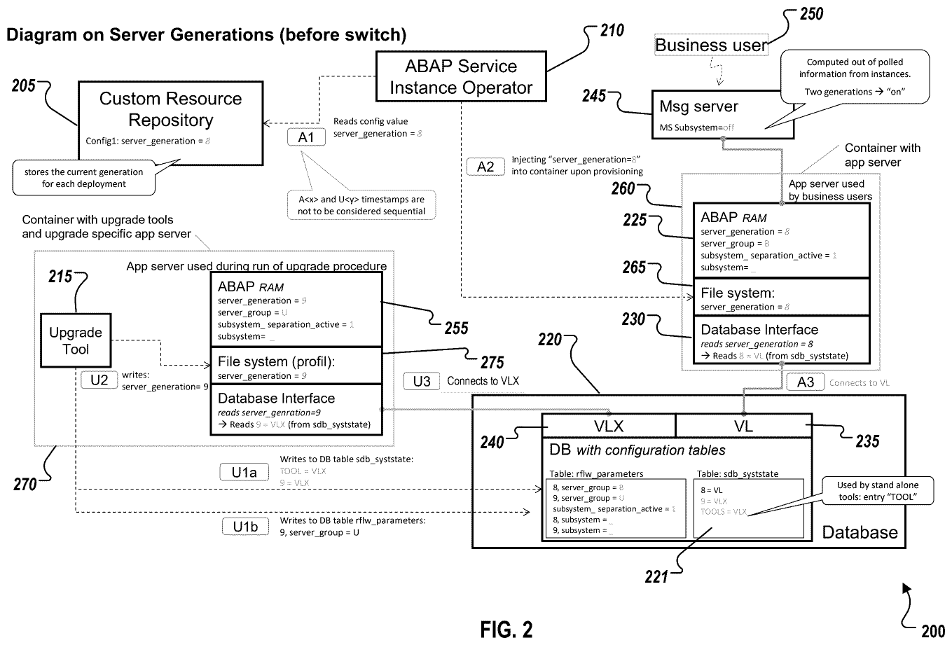

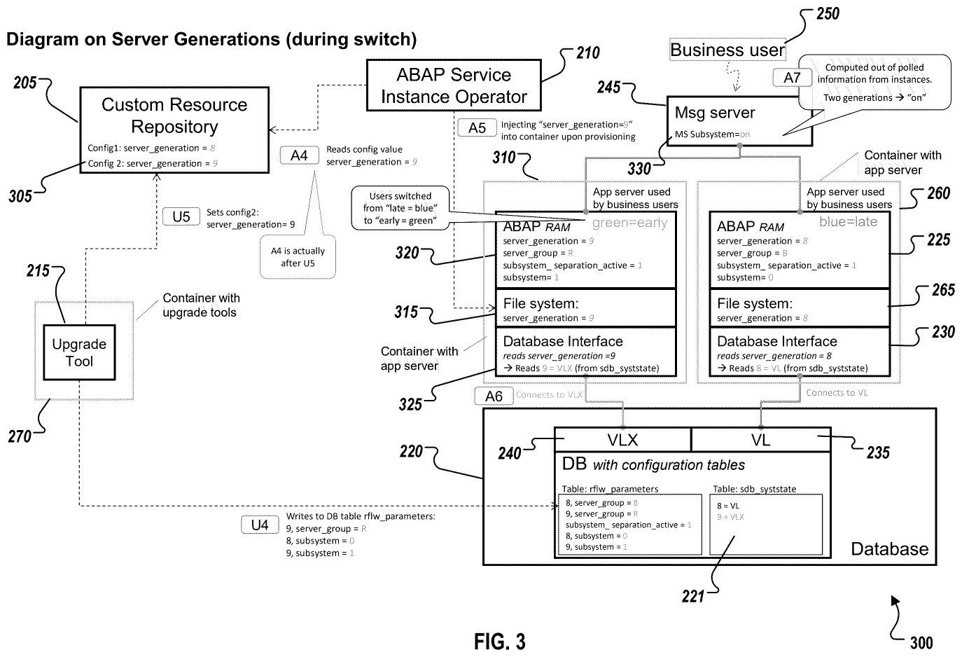

FIG. 1 is an illustration of example parameters 100 involved in the described approach, according to an implementation of the present disclosure. Parameters involved include those classified under server configuration 105, profile parameters 110, message server 115, and connect 120. The parameters will be described in more detail with respect to the description of FIGS. 2 and 3.

FIG. 2 is a box diagram illustrating server generations before switch 200, according to an implementation of the present disclosure.

In the described approach, a computer system includes an operations infrastructure. The operations infrastructure includes: 1) a custom resource repository 205 storing a system instance specific configuration; 2) an advanced business application programming (ABAP) service instance operator 210, and an upgrade tool 215.

In some implementations, the custom resource repository 205 includes: 1) a server_generation configuration value; 2) configuration—how many (number of) application server instances (nr-of-instances) are to be started (not shown); and 3) other possible server configuration parameters consistent with this disclosure.

In some implementations, the ABAP service instance (ASI) operator 210 can read a configuration from the custom resource repository 205 and start as many application server containers as specified by the nr-of-instances configuration value. The ASI operator 210 can also inject the server_generation configuration value into a container, writing to a file system profile. Other server configuration parameters can also be written to the file system profile of a container by the ASI operator 210. The ASI operator 210 can start an application server in a container, with the application server reading profile parameters from the file system.

In some implementations, the upgrade tool 215 can read the current value of the server_generation from the system DB 220 or repository configuration of the system from the custom resource repository 205. Configuration values can be written to the system DB and to the repository configuration of the system in the custom resource repository 205. Configuration parameters can be written server_generation individual to the system DB, meaning that a value can be written for a configuration parameter for two server generation values (e.g., one parameter value for generation x and one parameter value for generation x+1). The upgrade tool 215 can also execute required upgrade process steps for the system DB 220 and the content in the system DB 220 as well as all the system DB 220 tables and views in the system DB 220 to create a new version of the application.

Upgrade management component(s) in application servers (e.g., application server 225), upon startup of the application server 225, the application server 225 reads profile parameters. A database interface (DBI) 230 is passed a value of a server_generation read from file system profile parameters. The DBI 230 reads from a database table 221 the server_generation specific value of the DB schema to connect to (this can be the blue or green schema (in FIGS. 2 and 3, VL 235 and VLX 240, respectively)). The application server 225 reads from the system DB 220 other configuration parameters, for configuration parameters, which are server_generation specific, and reads the values for the generation specified in the file system profile parameters. The application server 225 communicates with a message server 245 and provides server_generation value of the newly started application server 225 plus potentially other configuration values. The message server 245 can compute its own settings (e.g., “MS subsystem=on”) used for routing of business user (or other user) 250 requests to the application servers 225 of the blue or green DB schema (e.g., application server 255).

### Provisioning

The start configuration is created for the new system. First, in the custom resource repository 205, a system specific configuration is entered: 1) server_generation=1; 2) nr-of-instances=2 (or higher values, if a larger system is ordered); 3) server_generation specific parameters for server_generation 1; 4) other parameters, not server_generation specific. Note, a new system would normally start with server_generation=1. In the provided examples of at least FIGS. 1-3, while any other two numbers x and x+1 could have been used, here, an arbitrary change from server_generation 8 to 9 is used to aid in understanding. In the example of server_generations 8 and 9, the system would already have experienced seven upgrades (i.e., 1->2, 2->3, 3->4, 4->5, 5->6, 6->7, 7->8).

A system DB 220 instance is provisioned, and configuration parameters are written to the system DB 220: 1) For server_generation, the system DB 220 schema to connect to is VL 235 and 2) other parameters as the standard configuration (e.g., in the diagram subsystem_separation_active=1 server_group=B, etc.).

The ASI operator 210 is triggered to deploy a system with the specified configuration:

At [A1], the ASI operator 210 reads the configuration, creates and starts a container 260 with the message server 245.

At [A2], the ASI operator 210 reads the configuration nr-of-instances and server_generation and: 1) creates as many application server containers as specified at “nr-of-instances”; 2) injects the value of server_generation=8 into the file system 265 of the container; 3) injects other parameters: server_generation specific parameters for server_generation 8, and parameters, not server_generation specific; and 4) starts the application server 225 in the container 260.

The application server 225 and message server 245:

The application server 225 reads the profile parameter server_generation=8.

The DBI 230 is passed the value (1) of the server_generation read from file system 265 profile parameters.

At [A3], the DBI 230 reads from the system DB 220 table the server_generation specific value of the DB schema to connect to (i.e., VL 235).

The application server 225 reads from the system DB 220 other configuration parameters. For configuration parameters which are server_generation specific, reads the values for the generation specified in the file system 265 profile parameters.

The application server 225 communicates with the message server 245 and provides the server_generation value of the newly started application server 225 plus potentially other configuration values.

The message server 245 at this stage communicates with application servers of only one server_generation, therefore computes, i.e. “MS subsystem=off”.

### Scale-Out/In

A desired configuration is written for the selected system:

In the repository, system specific configuration is updated: 1) server_generation=<x> (value is unchanged); 2) nr-of-instances=4 (increased or decreased, e.g. set to 4); 3) server_generation specific parameters for generation <x>; 4) other parameters, not server_generation specific.

The ASI operator 210 is triggered to adjust the specified system to the stored configuration.

At [A1], the ASI operator 210 reads the configuration nr-of-instances and server_generation and:

If the nr-of-instances is lower than the current number of running instances, an instance is stopped and the container 260 is de-commissioned.

If the nr-of-instances is higher than the current number of running instances: 1) creates an additional application server container 260 (or several, depending on how many are missing); 2) [A2] Injects the value of server_generation=<x> into the file system 265 of the container; 3) injects other parameters: server_generation specific parameters for server_generation <x>, and parameters, not server_generation specific; and starts the application server 225 in the container 260.

The application server 225 and message server 245 execute as described with provisioning (continuing with same steps as above . . . [A3]).

### Upgrade

The upgrade container 270 with the upgrade tool 215 is provisioned and configured with the system identifier and connect credentials for the system to upgrade.

The upgrade tool 215 is started in the upgrade container 270.

The upgrade tool 215 executes:

1) The upgrade tool 215 reads a current value of the server_generation (i.e. <x>) (e.g., the upgrade tool 215 can read the current value of the server_generation from the system DB 220 or the custom resource repository 205).

The upgrade tool 215 determines, which DB schema in the system DB 220 is in use (i.e. “VL” 235).

2) [U1a] upgrade tool 215 writes a configuration to the system DB 220 that for generation <x+1> the schema is “VLX” 240.

3) [U1a] upgrade tool 215 writes a configuration to the system DB 220 that for tools during the upgrade the schema is “VLX” 240.

4) [U1b] upgrade tool 215 prepares the DB schema in the system DB 220 for the new release (i.e. “VLX” 240).

5) Upgrade tool 215 creates an application server 255 instance in the upgrade container 270. [U2] upgrade tool 215 writes to the file system 275 profile, server_generation=<x+1> and 2) upgrade tool 215 starts the application server 255: a) The application server reads server_generation=<x+1>; b) [U3] It reads from the system DB 220 to connect to DB schema “VLX” 240; c) the application server 255 reads further parameters for generation <x+1>; d) if the system in the upgrade container 270 is configured to have a custom message server, no further action is performed; e) If the application server 255 in the upgrade container 270 is configured to use the system message server 245 already running, the application server 255 communicates with the message server 245. Here, the system message server 245 identifies that application servers of two server_generations are connected and computes custom configuration settings (i.e., “MS subsystem=on”) and the application server instances 255 in the upgrade container 270 are configured to form a custom subsystem and no business user request 250 is routed here, and no upgrade request is routed to the application server instances 225 of the business.

6) Upgrade tool 215 executes upgrade actions using the started application server 255 in the upgrade container 270.

7) Upgrade tool 215 stops the application server 255 in the upgrade container 270.

8) [U4] Upgrade tool 215 writes configuration to the system DB 220 that for application servers using generation schema <x+1> and “VLX” 240.

9) [U5] Upgrade tool 215 configures the custom resource repository 205 of the ASI operator 210 to create a generation <x+1> entry (e.g., “Config 2: server_generation=9” as in FIG. 3). Profile parameters can be copied from generation <x>, or profile parameters can be set to new values, based on other configuration rules.

FIG. 3 is a box diagram illustrating server generations during switch 300, according to an implementation of the present disclosure.

At [A4], the ASI operator 210 is triggered to read the configuration from the custom resource repository 205. The ASI operator 210 identifies a new entry for server_generation <x+1> (e.g., “Config 2: server_generation=9”) and creates as many containers 310 as specified at “nr-of-instances.”

At [A5], the ASI operator 210 injects the value of server_generation=<x+1> into the file system 315 of the container 310. Other parameters are also injected: server_generation specific parameters for server_generation <x+1> and parameters not server_generation specific.

The ASI operator 210 starts an application server(s) 320 in the container 310.

The application server 320 reads the profile parameter server_generation=<x+1>.

The DBI 325 is passed the value (<x+1>) of the server_generation read from file system 315 profile parameters.

At [A6], the DBI 325 reads from the database table 221 the server_generation specific value of the DB schema to connect to for server_generation <x+1> (e.g., here 9=VLX).

The application server 320 reads from the system DB 220 other configuration parameters for configuration parameters which are server_generation specific and reads values for the generation specified in the file system 315 profile parameters. The application server 320 communicates with the message server 245 and provides the server_generation value of the newly started application server 320 plus potentially other configuration values.

At [A7], The message server 245 communicates with application servers of two server_generations (i.e., 225 (generation 8) and 320 (generation 9)), and computes “MS subsystem=on” at 330.

The upgrade tool 215 polls the state of the started application servers (i.e., 225 and 320).

When application servers of generation <x+1> (320) are started (and potentially another criteria matches), a switch of the users occurs:

1) user requests are routed to application server instances 320 of generation <x+1>. Depending on switching methodology used: a) this is either done in asynchronously, and there is a period where requests are sent to <x> (225) and <x+1> (320) (e.g., for stateful applications depending on user session state) or b) this is done synchronously, where the requests are at some point no longer sent to <x> (225) but only sent to <x+1> (320). There can be a certain delay to ensure that requests are completed on <x> (225) before requests are sent to <x+1> (320).

2) the previous generation application servers <x> (225) are configured to stop. Here, the ASI operator 210 registry is updated and entries for server_generation <x> are removed (or archived). This step can include the previous step to trigger the switch of users.

3) The upgrade tool 215 executes some clean-up tasks. For example, unused system DB 220 schema VL 235 and other obsolete system DB 220 artifacts which are not used by the new application version can be deleted.

The upgrade tool finishes with OK.

The upgrade container 270 is de-commissioned.

Scale-out/in during upgrade.

The desired configuration is written for the selected system:

1) In the custom resource repository 205, system specific configuration is updated. For example:
server_generation=<x> (value is unchanged).
server_generation specific parameters for generation <x>.
server_generation=<x+1> (value is unchanged).
server_generation specific parameters for generation <x+1>.
nr-of-instances=3 (increased or decreased, e.g. set to 3).
other parameters, not server_generation specific.

The ASI operator 210 is triggered to adjust a specified system to a stored configuration. The ASI operator 210 reads the configuration nr-of-instances and server_generation and, for each value of server_generation <i> (<x> and <x+1>):
If the nr-of-instances (for server generation <i>) is lower than the current number of running instances, an instance of server_generation <i> is stopped and the container is de-commissioned.
If the nr-of-instances (for server generation <i>) is higher than the current number of running instances: a) creates an additional application server container (or several, depending on how many are missing), 2) injects the value of server_generation=<i> into the file system of the container; 3) starts the application server in the container.

The application server (225 or 320) and message server 245 execute as described with provisioning.

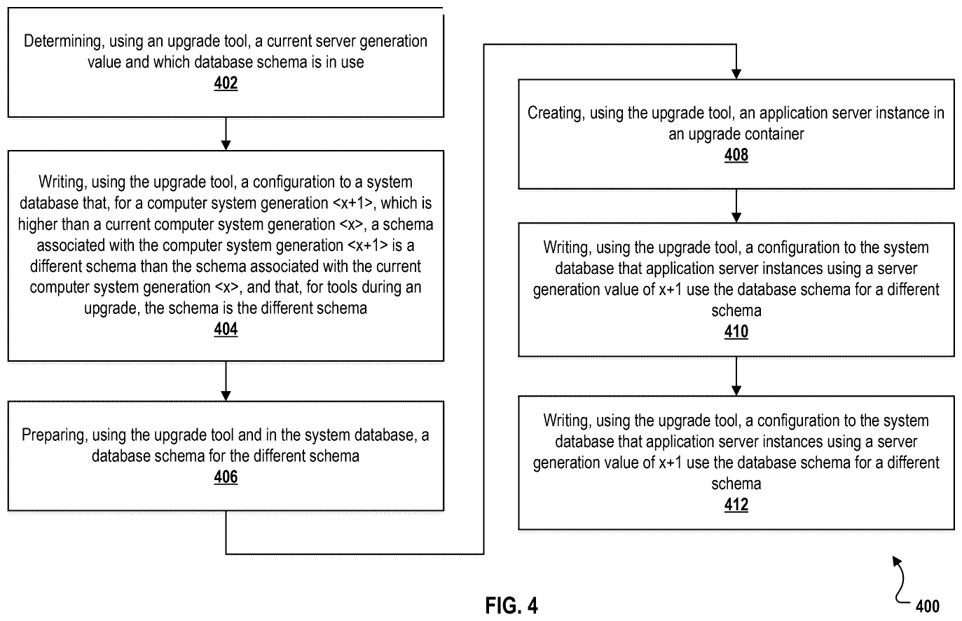

FIG. 4 is a flowchart illustrating an example of a computer-implemented method 400 for using server generations to enable blue-green upgrades in containerized environments, according to an implementation of the present disclosure. For clarity of presentation, the description that follows generally describes method 400 in the context of the other figures in this description. However, it will be understood that method 400 can be performed, for example, by any system, environment, software, and hardware, or a combination of systems, environments, software, and hardware, as appropriate. In some implementations, various steps of method 400 can be run in parallel, in combination, in loops, or in any order.

At 402, using an upgrade tool, a current server generation value and which database schema is in use is determined. From 402, method 400 proceeds to 404.

At 404, using the upgrade tool, writing a configuration to a system database that, for a computer system generation <x+1>, which is higher than a current computer system generation <x>, a schema associated with the computer system generation <x+1> is a different schema than the schema associated with the current computer system generation <x>, and that, for tools during an upgrade, the schema is the different schema. From 404, method 400 proceeds to 406.

At 406, using the upgrade tool and in the system database, preparing a database schema for the different schema. From 406, method 400 proceeds to 408.

At 408, using the upgrade tool, an application server instance in an upgrade container is created. In some implementations, creating, using the upgrade tool, an application server instance in an upgrade container, includes: writing, using the upgrade tool and to a file system associated with the application server instance in an upgrade container, the server generation value of <x+1>; starting, using the upgrade tool and with the server generation value of <x+1>, the application server instance in an upgrade container, where the application server instance in an upgrade container reads from the system database to connect to the database schema for the different schema; and communicating, by the application server instance in an upgrade container, with a system message server. From 408, method 400 proceeds to 410.

At 410, using the upgrade tool, a configuration is written to the system database that application server instances using a server generation value of x+1 use the database schema for a different schema. From 410, method 400 proceeds to 412.

At 412, using the upgrade tool, a custom resource repository is configured to create an entry for the server generation value of <x+1>. After 412, method 400 can stop.

In some implementations, an advanced business application programming (ABAP) service instance (ASI) operator reads a start configuration. The ASI operator creates a container associated with a message server. The ASI operator starts the container and the message server.

In some implementations, the ASI operator reads the start configuration. The ASI operator creates an application server container.

In some implementations, the ASI operator injects a value of a server generation value <x> into a file system of the application server container. The ASI operator injects other parameters into a file system of the application server container. The ASI operator starts, in the application server container, an application server of the server generation value <x>.

In some implementations, a database interface associated with the application server of the server generation value <x> reads from the system database a specific value of a database schema with which to connect.

In some implementations, the ASI operator is triggered to read a configuration from the custom resource repository. The ASI operator identifies a new entry for the server generation value <x+1>. The ASI operator creates an application server container.

In some implementations, the ASI operator injects a value of a server generation value <x+1> into a file system of the application server container. The ASI operator injects other parameters into a file system of the application server container. The ASI operator starts, in the application server container, an application server of the server generation value <x+1>.

In some implementations, a database interface associated with the application server of the server generation value <x+1> and from the system database reads a specific value of a database schema with which to connect.

In some implementations, the message server communicates with the application server of generation value <x> and the application server of generation value <x+1>. In some implementations, the upgrade tool switches user requests to the application server of generation value <x+1>.

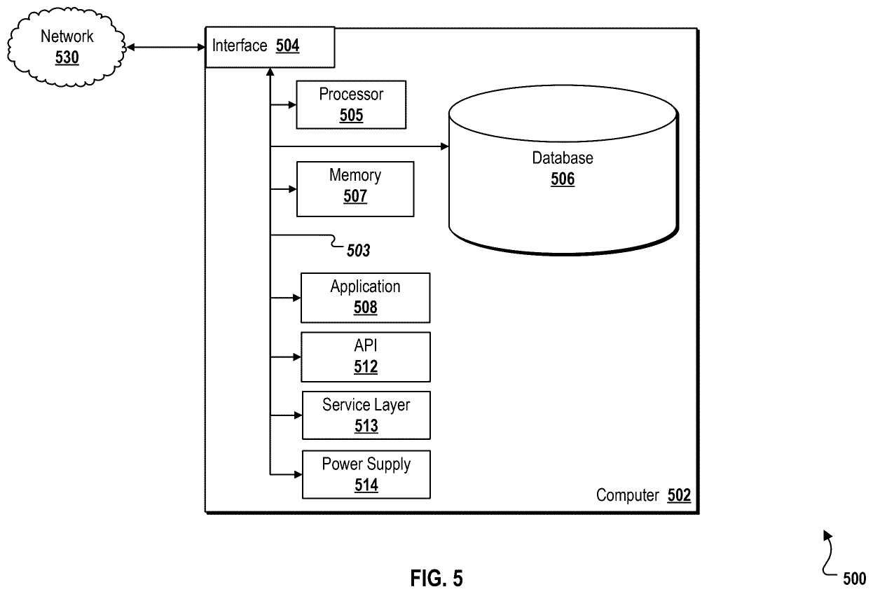

FIG. 5 is a block diagram illustrating an example of a computer-implemented System 500 used to provide computational functionalities associated with described algorithms, methods, functions, processes, flows, and procedures, according to an implementation of the present disclosure. In the illustrated implementation, computer-implemented system 500 includes a Computer 502 and a Network 530.

The illustrated Computer 502 is intended to encompass any computing device, such as a server, desktop computer, laptop/notebook computer, wireless data port, smart phone, personal data assistant (PDA), tablet computer, one or more processors within these devices, or a combination of computing devices, including physical or virtual instances of the computing device, or a combination of physical or virtual instances of the computing device. Additionally, the Computer 502 can include an input device, such as a keypad, keyboard, or touch screen, or a combination of input devices that can accept user information, and an output device that conveys information associated with the operation of the Computer 502, including digital data, visual, audio, another type of information, or a combination of types of information, on a graphical-type user interface (UI) (or GUI) or other UI.

The Computer 502 can serve in a role in a distributed computing system as, for example, a client, network component, a server, or a database or another persistency, or a combination of roles for performing the subject matter described in the present disclosure. The illustrated Computer 502 is communicably coupled with a Network 530. In some implementations, one or more components of the Computer 502 can be configured to operate within an environment, or a combination of environments, including cloud-computing, local, or global.

At a high level, the Computer 502 is an electronic computing device operable to receive, transmit, process, store, or manage data and information associated with the described subject matter. According to some implementations, the Computer 502 can also include or be communicably coupled with a server, such as an application server, e-mail server, web server, caching server, or streaming data server, or a combination of servers.

The Computer 502 can receive requests over Network 530 (for example, from a client software application executing on another Computer 502) and respond to the received requests by processing the received requests using a software application or a combination of software applications. In addition, requests can also be sent to the Computer 502 from internal users (for example, from a command console or by another internal access method), external or third-parties, or other entities, individuals, systems, or computers.

Each of the components of the Computer 502 can communicate using a System Bus 503. In some implementations, any or all of the components of the Computer 502, including hardware, software, or a combination of hardware and software, can interface over the System Bus 503 using an application programming interface (API) 512, a Service Layer 513, or a combination of the API 512 and Service Layer 513. The API 512 can include specifications for routines, data structures, and object classes. The API 512 can be either computer-language independent or dependent and refer to a complete interface, a single function, or even a set of APIs. The Service Layer 513 provides software services to the Computer 502 or other components (whether illustrated or not) that are communicably coupled to the Computer 502. The functionality of the Computer 502 can be accessible for all service consumers using the Service Layer 513. Software services, such as those provided by the Service Layer 513, provide reusable, defined functionalities through a defined interface. For example, the interface can be software written in a computing language (for example JAVA or C++) or a combination of computing languages, and providing data in a particular format (for example, extensible markup language (XML)) or a combination of formats. While illustrated as an integrated component of the Computer 502, alternative implementations can illustrate the API 512 or the Service Layer 513 as stand-alone components in relation to other components of the Computer 502 or other components (whether illustrated or not) that are communicably coupled to the Computer 502. Moreover, any or all parts of the API 512 or the Service Layer 513 can be implemented as a child or a sub-module of another software module, enterprise application, or hardware module without departing from the scope of the present disclosure.

The Computer 502 includes an Interface 504. Although illustrated as a single Interface 504, two or more Interfaces 504 can be used according to particular needs, desires, or particular implementations of the Computer 502. The Interface 504 is used by the Computer 502 for communicating with another computing system (whether illustrated or not) that is communicatively linked to the Network 530 in a distributed environment. Generally, the Interface 504 is operable to communicate with the Network 530 and includes logic encoded in software, hardware, or a combination of software and hardware. More specifically, the Interface 504 can include software supporting one or more communication protocols associated with communications such that the Network 530 or hardware of Interface 504 is operable to communicate physical signals within and outside of the illustrated Computer 502.

The Computer 502 includes a Processor 505. Although illustrated as a single Processor 505, two or more Processors 505 can be used according to particular needs, desires, or particular implementations of the Computer 502. Generally, the Processor 505 executes instructions and manipulates data to perform the operations of the Computer 502 and any algorithms, methods, functions, processes, flows, and procedures as described in the present disclosure.

The Computer 502 also includes a Database 506 that can hold data for the Computer 502, another component communicatively linked to the Network 530 (whether illustrated or not), or a combination of the Computer 502 and another component. For example, Database 506 can be an in-memory or conventional database storing data consistent with the present disclosure. In some implementations, Database 506 can be a combination of two or more different database types (for example, a hybrid in-memory and conventional database) according to particular needs, desires, or particular implementations of the Computer 502 and the described functionality. Although illustrated as a single Database 506, two or more databases of similar or differing types can be used according to particular needs, desires, or particular implementations of the Computer 502 and the described functionality. While Database 506 is illustrated as an integral component of the Computer 502, in alternative implementations, Database 506 can be external to the Computer 502. The Database 506 can hold and operate on at least any data type mentioned or any data type consistent with this disclosure.

The Computer 502 also includes a Memory 507 that can hold data for the Computer 502, another component or components communicatively linked to the Network 530 (whether illustrated or not), or a combination of the Computer 502 and another component. Memory 507 can store any data consistent with the present disclosure. In some implementations, Memory 507 can be a combination of two or more different types of memory (for example, a combination of semiconductor and magnetic storage) according to particular needs, desires, or particular implementations of the Computer 502 and the described functionality. Although illustrated as a single Memory 507, two or more Memories 507 or similar or differing types can be used according to particular needs, desires, or particular implementations of the Computer 502 and the described functionality. While Memory 507 is illustrated as an integral component of the Computer 502, in alternative implementations, Memory 507 can be external to the Computer 502.

The Application 508 is an algorithmic software engine providing functionality according to particular needs, desires, or particular implementations of the Computer 502, particularly with respect to functionality described in the present disclosure. For example, Application 508 can serve as one or more components, modules, or applications. Further, although illustrated as a single Application 508, the Application 508 can be implemented as multiple Applications 508 on the Computer 502. In addition, although illustrated as integral to the Computer 502, in alternative implementations, the Application 508 can be external to the Computer 502.

The Computer 502 can also include a Power Supply 514. The Power Supply 514 can include a rechargeable or non-rechargeable battery that can be configured to be either user- or non-user-replaceable. In some implementations, the Power Supply 514 can include power-conversion or management circuits (including recharging, standby, or another power management functionality). In some implementations, the Power Supply 514 can include a power plug to allow the Computer 502 to be plugged into a wall socket or another power source to, for example, power the Computer 502 or recharge a rechargeable battery.

There can be any number of Computers 502 associated with, or external to, a computer system containing Computer 502, each Computer 502 communicating over Network 530. Further, the term “client,” “user,” or other appropriate terminology can be used interchangeably, as appropriate, without departing from the scope of the present disclosure. Moreover, the present disclosure contemplates that many users can use one Computer 502, or that one user can use multiple computers 502.

Described implementations of the subject matter can include one or more features, alone or in combination.

For example, in a first implementation, a computer-implemented method, comprising: determining, using an upgrade tool, a current server generation value and which database schema is in use; writing, using the upgrade tool, a configuration to a system database that, for a computer system generation <x+1>, which is higher than a current computer system generation <x>, a schema associated with the computer system generation <x+1> is a different schema than the schema associated with the current computer system generation <x>, and that, for tools during an upgrade, the schema is the different schema; preparing, using the upgrade tool and in the system database, a database schema for the different schema; creating, using the upgrade tool, an application server instance in an upgrade container; writing, using the upgrade tool, a configuration to the system database that application server instances using a server generation value of x+1 use the database schema for a different schema; and configuring, using the upgrade tool, a custom resource repository to create an entry for the server generation value of <x+1>.

The foregoing and other described implementations can each, optionally, include one or more of the following features:

A first feature, combinable with any of the following features, wherein, creating, using the upgrade tool, an application server instance in an upgrade container, comprises: writing, using the upgrade tool and to a file system associated with the application server instance in an upgrade container, the server generation value of <x+1>; starting, using the upgrade tool and with the server generation value of <x+1>, the application server instance in an upgrade container, wherein the application server instance in an upgrade container reads from the system database to connect to the database schema for the different schema; and communicating, by the application server instance in an upgrade container, with a system message server.

A second feature, combinable with any of the previous or following features, comprising: reading, by an advanced business application programming (ABAP) service instance (ASI) operator, a start configuration; creating, by the ASI operator, a container associated with a message server; and starting, by the ASI operator, the container and the message server.

A third feature, combinable with any of the previous or following features, comprising: reading, by the ASI operator, the start configuration; and creating, by the ASI operator, an application server container.

A fourth feature, combinable with any of the previous or following features, comprising: injecting, by the ASI operator, a value of a server generation value <x> into a file system of the application server container; injecting, by the ASI operator, other parameters into a file system of the application server container; and starting, by the ASI operator and in the application server container, an application server of the server generation value <x>.

A fifth feature, combinable with any of the previous or following features, comprising: reading, by a database interface associated with the application server of the server generation value <x> and from the system database, a specific value of a database schema with which to connect.

A sixth feature, combinable with any of the previous or following features, comprising: triggering the ASI operator to read a configuration from the custom resource repository; identifying, by the ASI operator, a new entry for the server generation value <x+1>; and creating, by the ASI operator, an application server container.

A seventh feature, combinable with any of the previous or following features, comprising: injecting, by the ASI operator, a value of a server generation value <x+1> into a file system of the application server container; injecting, by the ASI operator, other parameters into a file system of the application server container; and starting, by the ASI operator and in the application server container, an application server of the server generation value <x+1>.

An eighth feature, combinable with any of the previous or following features, comprising: reading, by a database interface associated with the application server of the server generation value <x+1> and from the system database, a specific value of a database schema with which to connect.

A ninth feature, combinable with any of the previous or following features, comprising: communicating, by the message server, with the application server of generation value <x> and the application server of generation value <x+1>; and switching, by the upgrade tool, user requests to the application server of generation value <x+1>.

In a second implementation, A non-transitory, computer-readable medium storing one or more instructions executable by a computer system to perform one or more operations, comprising: determining, using an upgrade tool, a current server generation value and which database schema is in use; writing, using the upgrade tool, a configuration to a system database that, for a computer system generation <x+1>, which is higher than a current computer system generation <x>, a schema associated with the computer system generation <x+1> is a different schema than the schema associated with the current computer system generation <x>, and that, for tools during an upgrade, the schema is the different schema; preparing, using the upgrade tool and in the system database, a database schema for the different schema; creating, using the upgrade tool, an application server instance in an upgrade container; writing, using the upgrade tool, a configuration to the system database that application server instances using a server generation value of x+1 use the database schema for a different schema; and configuring, using the upgrade tool, a custom resource repository to create an entry for the server generation value of <x+1>.

The foregoing and other described implementations can each, optionally, include one or more of the following features:

A first feature, combinable with any of the following features, wherein, creating, using the upgrade tool, an application server instance in an upgrade container, comprises: writing, using the upgrade tool and to a file system associated with the application server instance in an upgrade container, the server generation value of <x+1>; starting, using the upgrade tool and with the server generation value of <x+1>, the application server instance in an upgrade container, wherein the application server instance in an upgrade container reads from the system database to connect to the database schema for the different schema; and communicating, by the application server instance in an upgrade container, with a system message server.

A second feature, combinable with any of the previous or following features, comprising: reading, by an advanced business application programming (ABAP) service instance (ASI) operator, a start configuration; creating, by the ASI operator, a container associated with a message server; and starting, by the ASI operator, the container and the message server.

A third feature, combinable with any of the previous or following features, comprising: reading, by the ASI operator, the start configuration; and creating, by the ASI operator, an application server container.

A fourth feature, combinable with any of the previous or following features, comprising: injecting, by the ASI operator, a value of a server generation value <x> into a file system of the application server container; injecting, by the ASI operator, other parameters into a file system of the application server container; and starting, by the ASI operator and in the application server container, an application server of the server generation value <x>.

A fifth feature, combinable with any of the previous or following features, comprising: reading, by a database interface associated with the application server of the server generation value <x> and from the system database, a specific value of a database schema with which to connect.

A sixth feature, combinable with any of the previous or following features, comprising: triggering the ASI operator to read a configuration from the custom resource repository; identifying, by the ASI operator, a new entry for the server generation value <x+1>; and creating, by the ASI operator, an application server container.

A seventh feature, combinable with any of the previous or following features, comprising: injecting, by the ASI operator, a value of a server generation value <x+1> into a file system of the application server container; injecting, by the ASI operator, other parameters into a file system of the application server container; and starting, by the ASI operator and in the application server container, an application server of the server generation value <x+1>.

An eighth feature, combinable with any of the previous or following features, comprising: reading, by a database interface associated with the application server of the server generation value <x+1> and from the system database, a specific value of a database schema with which to connect.

A ninth feature, combinable with any of the previous or following features, comprising: communicating, by the message server, with the application server of generation value <x> and the application server of generation value <x+1>; and switching, by the upgrade tool, user requests to the application server of generation value <x+1>.

In a third implementation, A computer-implemented system, comprising: one or more computers; and one or more computer memory devices interoperably coupled with the one or more computers and having tangible, non-transitory, machine-readable media storing one or more instructions that, when executed by the one or more computers, perform one or more operations, comprising: determining, using an upgrade tool, a current server generation value and which database schema is in use; writing, using the upgrade tool, a configuration to a system database that, for a computer system generation <x+1>, which is higher than a current computer system generation <x>, a schema associated with the computer system generation <x+1> is a different schema than the schema associated with the current computer system generation <x>, and that, for tools during an upgrade, the schema is the different schema; preparing, using the upgrade tool and in the system database, a database schema for the different schema; creating, using the upgrade tool, an application server instance in an upgrade container; writing, using the upgrade tool, a configuration to the system database that application server instances using a server generation value of x+1 use the database schema for a different schema; and configuring, using the upgrade tool, a custom resource repository to create an entry for the server generation value of <x+1>.

The foregoing and other described implementations can each, optionally, include one or more of the following features:

A first feature, combinable with any of the following features, wherein, creating, using the upgrade tool, an application server instance in an upgrade container, comprises: writing, using the upgrade tool and to a file system associated with the application server instance in an upgrade container, the server generation value of <x+1>; starting, using the upgrade tool and with the server generation value of <x+1>, the application server instance in an upgrade container, wherein the application server instance in an upgrade container reads from the system database to connect to the database schema for the different schema; and communicating, by the application server instance in an upgrade container, with a system message server.

A second feature, combinable with any of the previous or following features, comprising: reading, by an advanced business application programming (ABAP) service instance (ASI) operator, a start configuration; creating, by the ASI operator, a container associated with a message server; and starting, by the ASI operator, the container and the message server.

A third feature, combinable with any of the previous or following features, comprising: reading, by the ASI operator, the start configuration; and creating, by the ASI operator, an application server container.

A fourth feature, combinable with any of the previous or following features, comprising: injecting, by the ASI operator, a value of a server generation value <x> into a file system of the application server container; injecting, by the ASI operator, other parameters into a file system of the application server container; and starting, by the ASI operator and in the application server container, an application server of the server generation value <x>.

A fifth feature, combinable with any of the previous or following features, comprising: reading, by a database interface associated with the application server of the server generation value <x> and from the system database, a specific value of a database schema with which to connect.

A sixth feature, combinable with any of the previous or following features, comprising: triggering the ASI operator to read a configuration from the custom resource repository; identifying, by the ASI operator, a new entry for the server generation value <x+1>; and creating, by the ASI operator, an application server container.

A seventh feature, combinable with any of the previous or following features, comprising: injecting, by the ASI operator, a value of a server generation value <x+1> into a file system of the application server container; injecting, by the ASI operator, other parameters into a file system of the application server container; and starting, by the ASI operator and in the application server container, an application server of the server generation value <x+1>.

An eighth feature, combinable with any of the previous or following features, comprising: reading, by a database interface associated with the application server of the server generation value <x+1> and from the system database, a specific value of a database schema with which to connect.

A ninth feature, combinable with any of the previous or following features, comprising: communicating, by the message server, with the application server of generation value <x>and the application server of generation value <x+1>; and switching, by the upgrade tool, user requests to the application server of generation value <x+1>.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs, that is, one or more modules of computer program instructions encoded on a tangible, non-transitory, computer-readable medium for execution by, or to control the operation of, a computer or computer-implemented system. Alternatively, or additionally, the program instructions can be encoded in/on an artificially generated propagated signal, for example, a machine-generated electrical, optical, or electromagnetic signal that is generated to encode information for transmission to a receiver apparatus for execution by a computer or computer-implemented system. The computer-storage medium can be a machine-readable storage device, a machine-readable storage substrate, a random or serial access memory device, or a combination of computer-storage mediums. Configuring one or more computers means that the one or more computers have installed hardware, firmware, or software (or combinations of hardware, firmware, and software) so that when the software is executed by the one or more computers, particular computing operations are performed. The computer storage medium is not, however, a propagated signal.

The term “real-time,” “real time,” “realtime,” “real (fast) time (RFT),” “near(ly) real-time (NRT),” “quasi real-time,” or similar terms (as understood by one of ordinary skill in the art), means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second(s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

The terms “data processing apparatus,” “computer,” “computing device,” or “electronic computer device” (or an equivalent term as understood by one of ordinary skill in the art) refer to data processing hardware and encompass all kinds of apparatuses, devices, and machines for processing data, including by way of example, a programmable processor, a computer, or multiple processors or computers. The computer can also be, or further include special-purpose logic circuitry, for example, a central processing unit (CPU), a field-programmable gate array (FPGA), or an application-specific integrated circuit (ASIC). In some implementations, the computer or computer-implemented system or special-purpose logic circuitry (or a combination of the computer or computer-implemented system and special-purpose logic circuitry) can be hardware- or software-based (or a combination of both hardware- and software-based). The computer can optionally include code that creates an execution environment for computer programs, for example, code that constitutes processor firmware, a protocol stack, a database management system, an operating system, or a combination of execution environments. The present disclosure contemplates the use of a computer or computer-implemented system with an operating system, for example LINUX, UNIX, WINDOWS, MAC OS, ANDROID, or IOS, or a combination of operating systems.

A computer program, which can also be referred to or described as a program, software, a software application, a unit, a module, a software module, a script, code, or other component can be written in any form of programming language, including compiled or interpreted languages, or declarative or procedural languages, and it can be deployed in any form, including, for example, as a stand-alone program, module, component, or subroutine, for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub-programs, or portions of code. A computer program can be deployed to be executed on one computer or on multiple computers that are located at one site or distributed across multiple sites and interconnected by a communication network.

While portions of the programs illustrated in the various figures can be illustrated as individual components, such as units or modules, that implement described features and functionality using various objects, methods, or other processes, the programs can instead include a number of sub-units, sub-modules, third-party services, components, libraries, and other components, as appropriate. Conversely, the features and functionality of various components can be combined into single components, as appropriate. Thresholds used to make computational determinations can be statically, dynamically, or both statically and dynamically determined.

Described methods, processes, or logic flows represent one or more examples of functionality consistent with the present disclosure and are not intended to limit the disclosure to the described or illustrated implementations, but to be accorded the widest scope consistent with described principles and features. The described methods, processes, or logic flows can be performed by one or more programmable computers executing one or more computer programs to perform functions by operating on input data and generating output data. The methods, processes, or logic flows can also be performed by, and computers can also be implemented as, special-purpose logic circuitry, for example, a CPU, an FPGA, or an ASIC.

Computers for the execution of a computer program can be based on general or special-purpose microprocessors, both, or another type of CPU. Generally, a CPU will receive instructions and data from and write to a memory. The essential elements of a computer are a CPU, for performing or executing instructions, and one or more memory devices for storing instructions and data. Generally, a computer will also include, or be operatively coupled to, receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a global positioning system (GPS) receiver, or a portable memory storage device, for example, a universal serial bus (USB) flash drive, to name just a few.

Non-transitory computer-readable media for storing computer program instructions and data can include all forms of permanent/non-permanent or volatile/non-volatile memory, media and memory devices, including by way of example semiconductor memory devices, for example, random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices; magnetic devices, for example, tape, cartridges, cassettes, internal/removable disks; magneto-optical disks; and optical memory devices, for example, digital versatile/video disc (DVD), compact disc (CD)-ROM, DVD+/−R, DVD-RAM, DVD-ROM, high-definition/density (HD)-DVD, and BLU-RAY/BLU-RAY DISC (BD), and other optical memory technologies. The memory can store various objects or data, including caches, classes, frameworks, applications, modules, backup data, jobs, web pages, web page templates, data structures, database tables, repositories storing dynamic information, or other appropriate information including any parameters, variables, algorithms, instructions, rules, constraints, or references. Additionally, the memory can include other appropriate data, such as logs, policies, security or access data, or reporting files. The processor and the memory can be supplemented by, or incorporated in, special-purpose logic circuitry.

To provide for interaction with a user, implementations of the subject matter described in this specification can be implemented on a computer having a display device, for example, a cathode ray tube (CRT), liquid crystal display (LCD), light emitting diode (LED), or plasma monitor, for displaying information to the user and a keyboard and a pointing device, for example, a mouse, trackball, or trackpad by which the user can provide input to the computer. Input can also be provided to the computer using a touchscreen, such as a tablet computer surface with pressure sensitivity or a multi-touch screen using capacitive or electric sensing. Other types of devices can be used to interact with the user. For example, feedback provided to the user can be any form of sensory feedback (such as, visual, auditory, tactile, or a combination of feedback types). Input from the user can be received in any form, including acoustic, speech, or tactile input. In addition, a computer can interact with the user by sending documents to and receiving documents from a client computing device that is used by the user (for example, by sending web pages to a web browser on a user's mobile computing device in response to requests received from the web browser).

The term “graphical user interface (GUI) can be used in the singular or the plural to describe one or more graphical user interfaces and each of the displays of a particular graphical user interface. Therefore, a GUI can represent any graphical user interface, including but not limited to, a web browser, a touch screen, or a command line interface (CLI) that processes information and efficiently presents the information results to the user. In general, a GUI can include a number of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server, or that includes a front-end component, for example, a client computer having a graphical user interface or a Web browser through which a user can interact with an implementation of the subject matter described in this specification, or any combination of one or more such back-end, middleware, or front-end components. The components of the system can be interconnected by any form or medium of wireline or wireless digital data communication (or a combination of data communication), for example, a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11x or other protocols, all or a portion of the Internet, another communication network, or a combination of communication networks. The communication network can communicate with, for example, Internet Protocol (IP) packets, frame relay frames, Asynchronous Transfer Mode (ATM) cells, voice, video, data, or other information between network nodes.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any inventive concept or on the scope of what can be claimed, but rather as descriptions of features that can be specific to particular implementations of particular inventive concepts. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features can be described as acting in certain combinations and even initially claimed as such, one or more features from a claimed combination can, in some cases, be excised from the combination, and the claimed combination can be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations can be considered optional), to achieve desirable results. In certain circumstances, multitasking or parallel processing (or a combination of multitasking and parallel processing) can be advantageous and performed as deemed appropriate.

The separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

What is claimed is:

1. A computer-implemented method, comprising:
determining, using an upgrade tool, a current server generation value and which database schema is in use;
writing, using the upgrade tool, a configuration to a system database that, for a computer system generation <x+1>, which is higher than a current computer system generation <x>, a schema associated with the computer system generation <x+1> is a different schema than the schema associated with the current computer system generation <x>, and that, for tools during an upgrade, the schema is the different schema;
preparing, using the upgrade tool and in the system database, a database schema for the different schema;
creating, using the upgrade tool, an application server instance in an upgrade container;
writing, using the upgrade tool, a configuration to the system database that application server instances using a server generation value of x+1 use the database schema for a different schema; and
configuring, using the upgrade tool, a custom resource repository to create an entry for the server generation value of <x+1>.

2. The computer-implemented method of claim 1, wherein, creating, using the upgrade tool, an application server instance in an upgrade container, comprises:
writing, using the upgrade tool and to a file system associated with the application server instance in an upgrade container, the server generation value of <x+1>;
starting, using the upgrade tool and with the server generation value of <x+1>, the application server instance in an upgrade container, wherein the application server instance in an upgrade container reads from the system database to connect to the database schema for the different schema; and
communicating, by the application server instance in an upgrade container, with a system message server.

3. The computer-implemented method of claim 1, comprising:
reading, by an advanced business application programming (ABAP) service instance (ASI) operator, a start configuration;
creating, by the ASI operator, a container associated with a message server; and
starting, by the ASI operator, the container and the message server.

4. The computer-implemented method of claim 3, comprising:
reading, by the ASI operator, the start configuration; and
creating, by the ASI operator, an application server container.

5. The computer-implemented method of claim 4, comprising:
injecting, by the ASI operator, a value of a server generation value <x> into a file system of the application server container;
injecting, by the ASI operator, other parameters into a file system of the application server container; and
starting, by the ASI operator and in the application server container, an application server of the server generation value <x>.

6. The computer-implemented method of claim 5, comprising:
reading, by a database interface associated with the application server of the server generation value <x> and from the system database, a specific value of a database schema with which to connect.

7. The computer-implemented method of claim 6, comprising:
triggering the ASI operator to read a configuration from the custom resource repository;
identifying, by the ASI operator, a new entry for the server generation value <x+1>; and
creating, by the ASI operator, an application server container.

8. The computer-implemented method of claim 7, comprising:
injecting, by the ASI operator, a value of a server generation value <x+1> into a file system of the application server container;
injecting, by the ASI operator, other parameters into a file system of the application server container; and
starting, by the ASI operator and in the application server container, an application server of the server generation value <x+1>.

9. The computer-implemented method of claim 8, comprising:
reading, by a database interface associated with the application server of the server generation value <x+1> and from the system database, a specific value of a database schema with which to connect.

10. The computer-implemented method of claim 9, comprising:
communicating, by the message server, with the application server of generation value <x> and the application server of generation value <x+1>; and
switching, by the upgrade tool, user requests to the application server of generation value <x+1>.

11. A non-transitory, computer-readable medium storing one or more instructions executable by a computer system to perform one or more operations, comprising:
determining, using an upgrade tool, a current server generation value and which database schema is in use;
writing, using the upgrade tool, a configuration to a system database that, for a computer system generation <x+1>, which is higher than a current computer system generation <x>, a schema associated with the computer system generation <x+1> is a different schema than the schema associated with the current computer system generation <x>, and that, for tools during an upgrade, the schema is the different schema;
preparing, using the upgrade tool and in the system database, a database schema for the different schema;
creating, using the upgrade tool, an application server instance in an upgrade container;
writing, using the upgrade tool, a configuration to the system database that application server instances using a server generation value of x+1 use the database schema for a different schema; and
configuring, using the upgrade tool, a custom resource repository to create an entry for the server generation value of <x+1>.

12. The non-transitory, computer-readable medium of claim 11, wherein, creating, using the upgrade tool, an application server instance in an upgrade container, comprises:
writing, using the upgrade tool and to a file system associated with the application server instance in an upgrade container, the server generation value of <x+1>;
starting, using the upgrade tool and with the server generation value of <x+1>, the application server instance in an upgrade container, wherein the application server instance in an upgrade container reads from the system database to connect to the database schema for the different schema; and
communicating, by the application server instance in an upgrade container, with a system message server.

13. The non-transitory, computer-readable medium of claim 11, comprising:
reading, by an advanced business application programming (ABAP) service instance (ASI) operator, a start configuration;
creating, by the ASI operator, a container associated with a message server; and
starting, by the ASI operator, the container and the message server.

14. The non-transitory, computer-readable medium of claim 13, comprising:
reading, by the ASI operator, the start configuration; and
creating, by the ASI operator, an application server container.

15. The non-transitory, computer-readable medium of claim 14, comprising:
injecting, by the ASI operator, a value of a server generation value <x> into a file system of the application server container;
injecting, by the ASI operator, other parameters into a file system of the application server container; and
starting, by the ASI operator and in the application server container, an application server of the server generation value <x>.

16. The non-transitory, computer-readable medium of claim 15, comprising:
reading, by a database interface associated with the application server of the server generation value <x> and from the system database, a specific value of a database schema with which to connect.

17. The non-transitory, computer-readable medium of claim 16, comprising:
triggering the ASI operator to read a configuration from the custom resource repository;
identifying, by the ASI operator, a new entry for the server generation value <x+1>; and
creating, by the ASI operator, an application server container.

18. The non-transitory, computer-readable medium of claim 17, comprising:
injecting, by the ASI operator, a value of a server generation value <x+1> into a file system of the application server container;
injecting, by the ASI operator, other parameters into a file system of the application server container; and
starting, by the ASI operator and in the application server container, an application server of the server generation value <x+1>.

19. The non-transitory, computer-readable medium of claim 18, comprising:
reading, by a database interface associated with the application server of the server generation value <x+1> and from the system database, a specific value of a database schema with which to connect.

20. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations, comprising:
determining, using an upgrade tool, a current server generation value and which database schema is in use;
writing, using the upgrade tool, a configuration to a system database that, for a computer system generation <x+1>, which is higher than a current computer system generation <x>, a schema associated with the computer system generation <x+1> is a different schema than the schema associated with the current computer system generation <x>, and that, for tools during an upgrade, the schema is the different schema;
preparing, using the upgrade tool and in the system database, a database schema for the different schema;
creating, using the upgrade tool, an application server instance in an upgrade container;
writing, using the upgrade tool, a configuration to the system database that application server instances using a server generation value of x+1 use the database schema for a different schema; and
configuring, using the upgrade tool, a custom resource repository to create an entry for the server generation value of <x+1>.
